(19) United States
(12) Patent Application Publication
(10) Pub. No.: US 2015/0037698 A1
(43) Pub. Date: Feb. 5, 2015

(54) ELECTROCHEMICAL SYSTEM COMPRISING AN INDUCTION HEATING SYSTEM

(71) Applicant: COMMISSARIAT A L'ENERGIE ATOMIQUE ET AUX ENE ALT, Paris (FR)

(72) Inventors: Didier BUZON, Grenoble (FR); Jean Oriol, Le Plessis-Trevise (FR)

(73) Assignee: COMMISSARIAT A L'ENERGIE ATOMIQUE ET AUX ENE ALT, Paris (FR)

(21) Appl. No.: 14/330,253

(22) Filed: Jul. 14, 2014

(30) Foreign Application Priority Data
Jul. 16, 2013 (FR) 13 56987

(51) Int. Cl. H01M 8/04; H01M 8/10; H01M 8/24

(52) U.S. Cl. CPC H01M 8/04007; H01M 8/24; H01M 8/10; H01M 8/04201; H01M 2008/1095; H01M 2250/20
USPC 429/429; 429/456

(57) ABSTRACT

Electrochemical system comprising a fuel cell comprising a stack (2) of electrochemical cells electrically connected to one another by bipolar plates (A, B, C) interposed between two successive electrochemical cells of the stack, where said stack (2) is positioned between two terminal plates (4), where said stack extends in a longitudinal axis (Z), where said electrochemical system comprises means for supplying the cells with reactive fluids, means of circulation of a heat-transfer fluid through the stack, and at least one induction heating system comprising a pair of inductors facing a lateral face of the stack, where the currents flowing in the two inductors flow in opposite directions.

### TECHNICAL FIELD AND PRIOR ART

The present invention relates to an electrochemical system comprising an induction heating system, in particular a fuel cell, notably for on-board applications.

Fuel cells, and in particular Proton Exchange Membrane Fuel Cells (PEMFC) are electrical generators which transform energy of an electrochemical type (hydrogen and oxygen) into electrical energy and water.

They contain one or more stacks of electrochemical cells. Each elementary cell consists of an MEA (Electrode Membrane Assembly) and of two electrical current collector conductive plates. Within an assembly the cells are connected in series directly by sharing the collector plates of two successive cells. From a practical standpoint two collector plates of two successive cells can be assembled by different methods which depend on the nature of the collector plates used. Two successive collector plates are assembled by means of an element designated a “bipolar plate”. The stack is received between two terminal plates mechanically holding the stack, and which can also incorporate the oxidising fluids, the fuel and heat-transfer fluid control channels.

In the case of PEMFCs the cells are formed from an anode, a cathode and a proton exchange membrane interposed between the anode and the cathode.

To optimise the stack's performance the reactive gases (oxidiser and fuel) are generally distributed in distribution channel networks either side of the membrane, directly formed within the bipolar plates. In operation, to ensure that the stack is of uniform temperature, it is cooled through the circulation of a heat-transfer fluid the distribution channels of which are directly incorporated within the bipolar plates.

In operation it is important to have excellent control of the spatial homogeneity of the reactive gases present within the fuel cell to prevent accelerated degradation of the cell; for example, it is important to limit the coexistence of an H2/O2 diffusion front on the anodic side when the hydrogen first penetrates in the anode, if oxygen is already present on the cathodic side.

In addition, currently, a fuel cell of the PEMFC type operates nominally at temperatures of between 65° C. and 85° C., but can operate at lower temperatures with an impaired level of performance. This low-temperature start capacity is used to start to the fuel cell, particularly when it is used in a motor vehicle. Once the cell is activated the heat generated within it by the electrochemical reaction is sufficient to cause the stack temperature to rise rapidly until it reaches nominal operating temperature.

But at low temperature the pure water contained in the cell (within the membranes and in the anodic and cathodic distribution channels) freezes as soon as the temperature is below freezing point within the medium in question. The presence of frozen water within the channels can obstruct a proportion of the active sites and of the gas distribution channels. This obstruction leads to non-uniform distribution of the reactive gases within the fuel cell. This can lead to degraded performance and reduce the lifetime of the electrochemical cells. The appearance of frozen water can also cause mechanical stresses.

It is therefore desirable to prevent the presence of frozen water before the cell is started.

Systems have been proposed to heat the cell and/or maintain it at a certain temperature.

Document US20120118878 discloses heating the heat-transfer fluid liquid in a tank separate from the cell stack by means of an induction heating system. To heat the stack all the elements of the cooling circuit must be heated. The heat capacity and the exchange surface with the environment of the cooling circuit are significant in relation to the stack. This results in a requirement to generate a large quantity of heat.

Document CA2368891 describes a fuel cell comprising a stack of cells in which the membranes incorporate a heating resistor wire. Firstly, such a system requires the development of specific membranes, and secondly the power connections of the resistor wires can be problematic.

Document US20050058865 describes a stack of proton exchange membrane cells incorporating heating resistors in thermal contact with the cells located at the ends of the stack. This solution is of use only for heating the cells located at the ends of the stack. Indeed, maintaining a PEMFC stack at a certain temperature, or heating one, by such a method is extremely lengthy, if the maximum temperature to which the cells located at the ends is taken into account.

### DESCRIPTION OF THE INVENTION

It is, consequently, one aim of the present invention to provide an electrochemical system comprising a stack of electrochemical cells, and heating means able to start the electrochemical system under improved conditions.

The aim of the present invention is attained through an electrochemical system comprising at least one stack of cells and one induction heating system configured such that the interconnection plates form the heating element of the induction heating system. The system can then be started rapidly, and it can also be maintained at a certain temperature. The interconnection plates within the stack are bipolar plates, and those located at the ends are designated “end bipolar plates”.

In other words the induction heating system comprises at least one inductor positioned such that the magnetic field which it generates induces a current in one or more interconnection plates of the stack. By this means the heat is generated directly within the stack, and there is no thermal loss. Since the interconnection plates are generally very thin the volume to be heated is small. The electrochemical device can then be rapidly put into operational mode, requiring very little energy.

Since the heating system is activated before the cell is started the heating system, and in particular the generated magnetic field, do not disturb the cell during its operation.

In one embodiment the inductor is coaxial with the stack. This embodiment has the advantage that it provides uniform heating.

In another embodiment at least one inductor is perpendicular to the axis of the stack and it is facing at least one face of the stack. Several inductors with parallel axes are preferably used to cover all or a proportion of the lateral surface of the stack.

Inductors can be used, for example to heat more specifically the bipolar end plates, where the induced current appears in the terminal plates and/or the bipolar plates of the monopolar cells located at the ends of the stack.

The subject-matter of the present invention is then an electrochemical system comprising at least one electrochemical device comprising a stack of electrochemical cells connected electrically to one another by bipolar plates interposed between two successive electrochemical cells of the stack, where the stack is positioned between two terminal plates, where the stack extends along an axis, where the electrochemical system comprises means to supply the cells with reactive fluids, means for circulation of a heat-transfer fluid to flow through the stack, and at least one induction heating system comprising at least one inductor, characterised in that said inductor is positioned relative to the stack so as to cause the appearance of induced current in at least one bipolar plate, causing said bipolar plate to be heated by the Joule effect.

In one embodiment the axis of the inductor is coaxial with the stack, where the inductor is designated the first inductor.

The first inductor can be positioned around the stack in a manner roughly coaxial with the stack.

The first inductor can extend throughout the full height of the stack.

In another embodiment the axis of the inductor is roughly perpendicular to the axis of the stack, designated the “second inductor”.

The second inductor can be positioned opposite at least one lateral face of the stack.

The electrochemical system can comprise at least two second inductors opposite at least one common lateral face, where the current flowing in one of the inductors flows in a direction opposite to that of the current flowing in the other inductor. The stack can have a polygonal cross-section, the second inductor(s) then being shaped such that they face at least two lateral faces.

The inductor(s) is/are preferably installed on a support plate attached to at least one terminal plate.

At least one second inductor can be positioned around or in proximity to a terminal plate.

The first inductor can be mounted on at least one terminal plate on its face opposite the one orientating towards the stack.

The electrochemical system can advantageously comprise an alternating current power source and an inverter.

If the electrochemical device comprises several stacks said heating system can heat at least one stack.

The electrochemical device can be a fuel cell, for example of the PEMFC type.

Another subject-matter of the present invention is a method for manufacturing an electrochemical system according to the present invention, comprising the following steps:
activation of the heating system by induction outside an operational phase of the electrochemical device,
heating of the stack by generation of an induced current in at least one connection plate,
shutdown of the heating system,
start of the electrochemical device.

In one operational example the heating system can be activated after a prolonged period of shutdown of the electrochemical device, in which the heating system switches off when the temperature within the stack is higher than the melting point of water which may be inside the electrochemical generator.

In another operational example the heating system is activated when there is a shutdown of short duration of the electrochemical device, so as to maintain the stack of the electrochemical device at a certain temperature.

The alternating current can have a variable frequency.

A heat-transfer fluid advantageously flows during the heating phase.

### BRIEF DESCRIPTION OF THE ILLUSTRATIONS

The present invention will be better understood using the description which follows and the appended illustrations, in which:

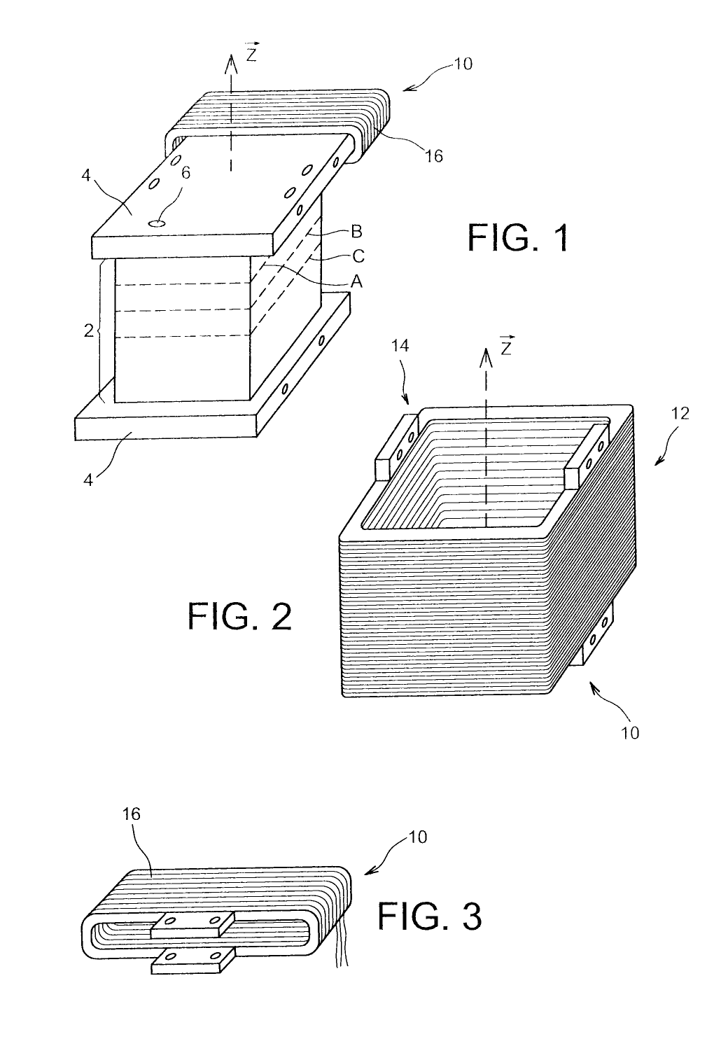

FIG. 1 is a perspective view of an embodiment of an electrochemical system and of its direct heating system represented schematically,

FIG. 2 is a perspective view of an inductor which can be used in the embodiment of FIG. 1,

FIG. 3 is a perspective view of another inductor which can be used in the embodiment of FIG. 1,

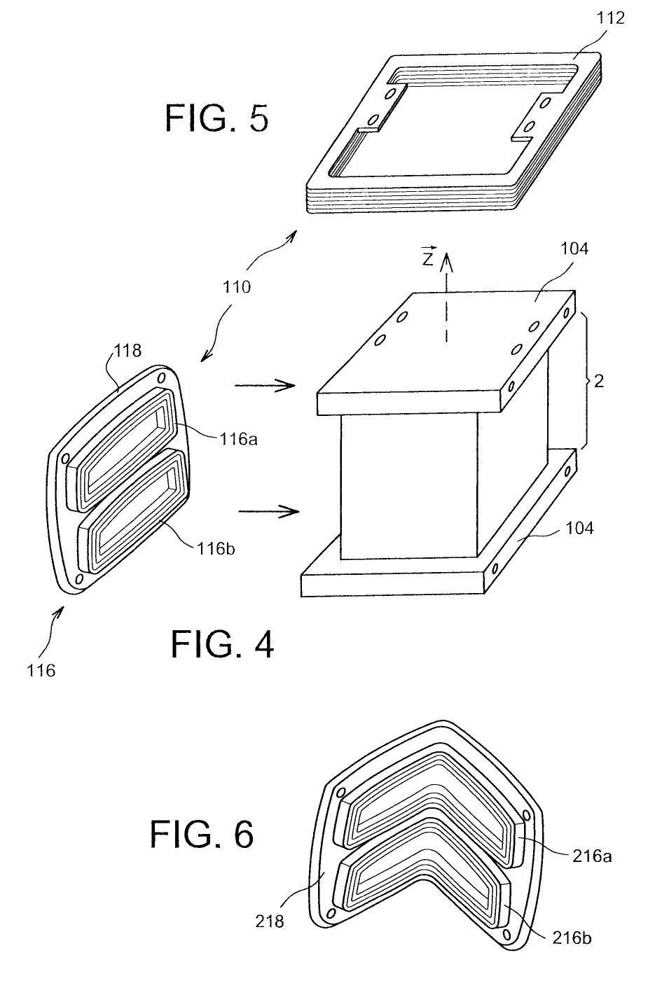

FIG. 4 is a perspective view of another embodiment of an electrochemical system and of its direct heating system represented schematically,

FIG. 5 is a perspective view of another example of inductors which can be used in the embodiment of FIG. 4

FIG. 6 is a perspective view of another inductor which can be used in the embodiment of FIG. 4,

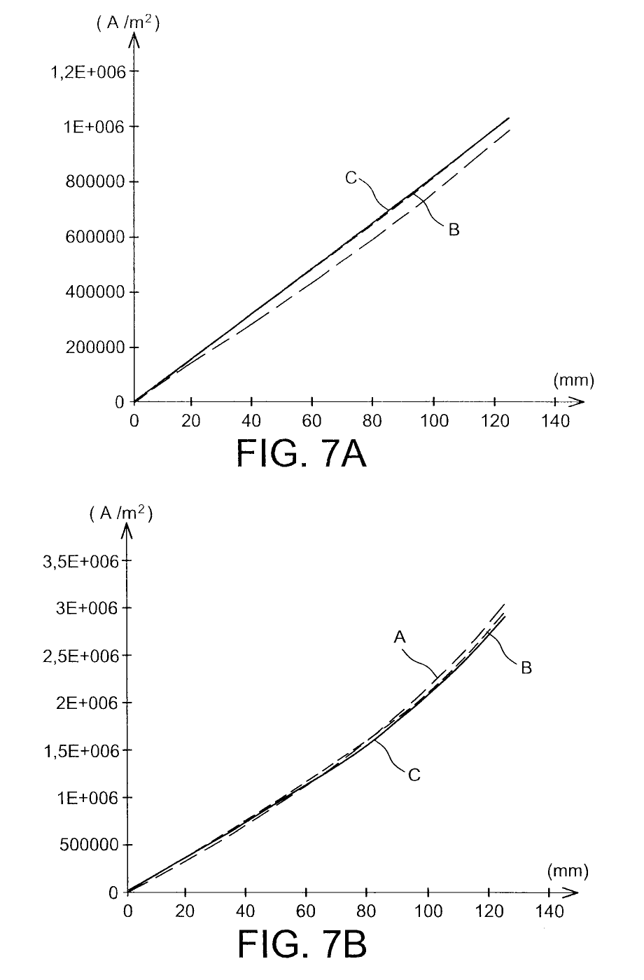

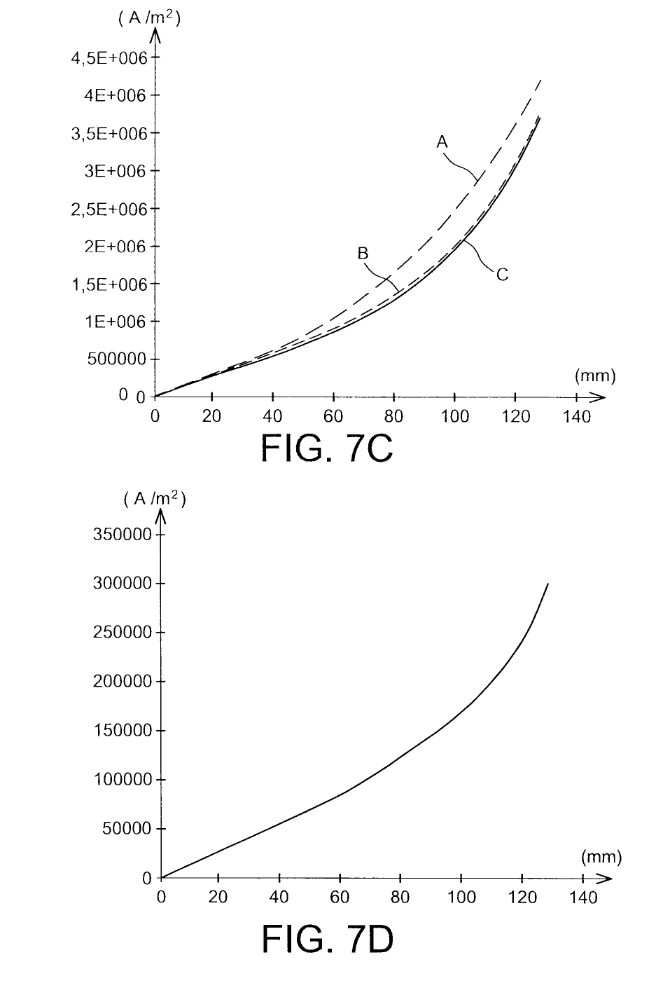

FIGS. 7A to 7C are graphical representations of the variation of the induced current density, in A/m², in the bipolar plates as a function of the distance relative to the axis of the stack, in mm, for different current densities and/or frequencies in the case of the embodiment of FIG. 1 with only one coaxial inductor 12 for the stack, where the bipolar plates are made of metal,

FIG. 7D is a graphical representation of the variation of the induced current density, in A/m², as a function of the distance relative to the axis of the stack, in mm, in the bipolar end plates of the stack in the case of the embodiment of FIG. 1, where one coaxial inductor 12 for the stack is present and one inductor 16 is positioned around one of the terminal plates,

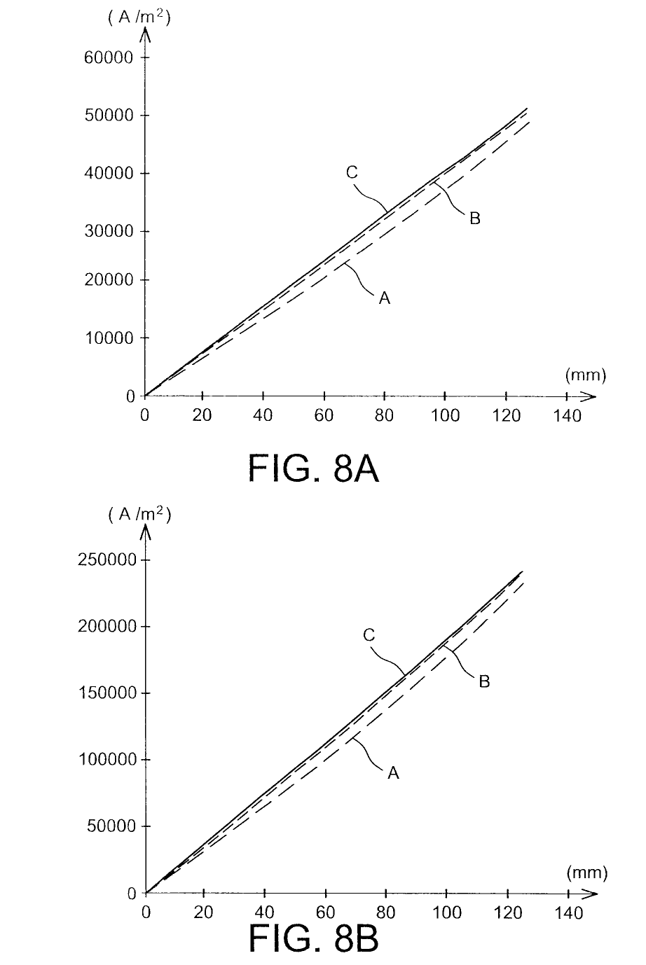

FIGS. 8A and 8B are graphical representations of the variation of the current density induced, in A/m², in the bipolar plates as a function of distance relative to the stack, in mm, for two frequencies 200 Hz and 1000 Hz respectively, where the bipolar plates are made of a composite graphite-filled material;

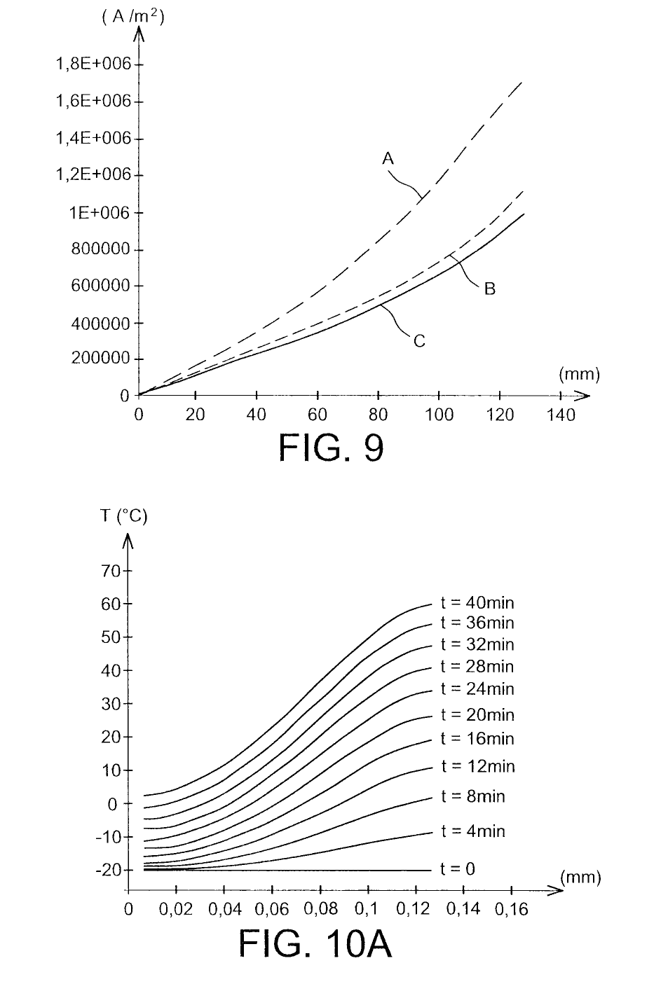

FIG. 9 is a graphical representation of the variation of the current density induced, in A/m², as a function of distance relative to the axis of the stack, in mm, in the bipolar plates in the case of the embodiment of FIG. 4,

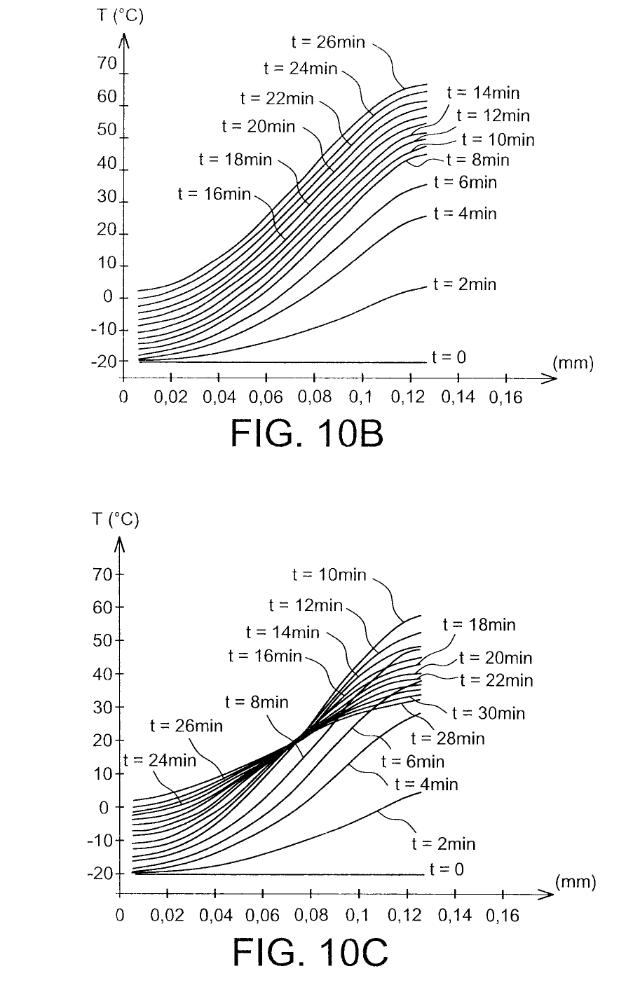

FIGS. 10A to 10C are graphical representations of the temperature profile, in ° C., as a function of the distance relative to the stack-axis, in m, according to three different heating strategies for metal bipolar plates, without any heat-transfer fluid flow,

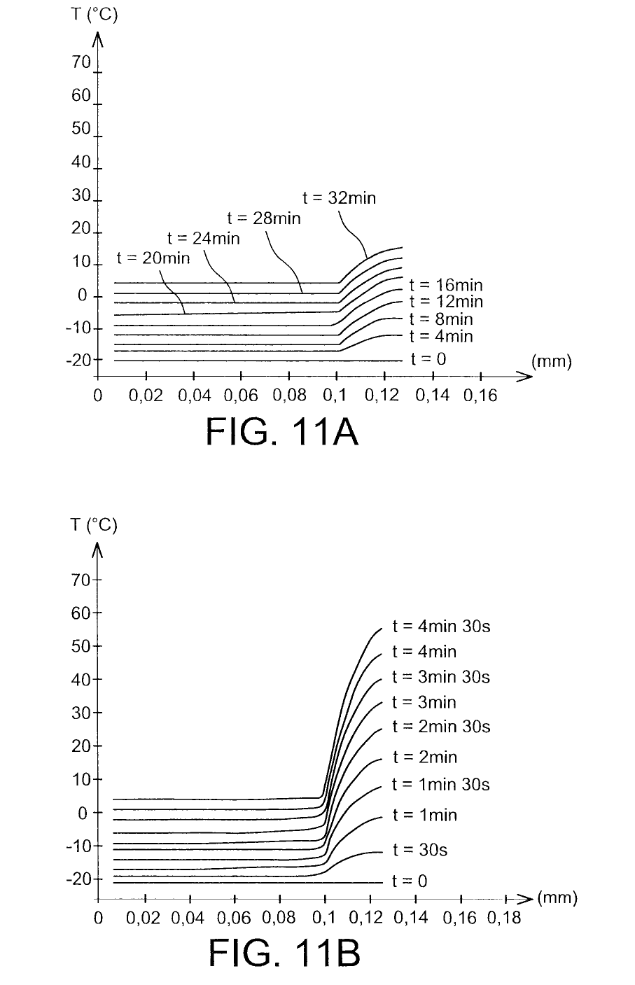

FIGS. 11A and 11B are graphical representations of the temperature profile, in ° C., as a function of the distance relative to the stack-axis, in m, according to three different heating strategies for metal bipolar plates, where a heat-transfer fluid flows,

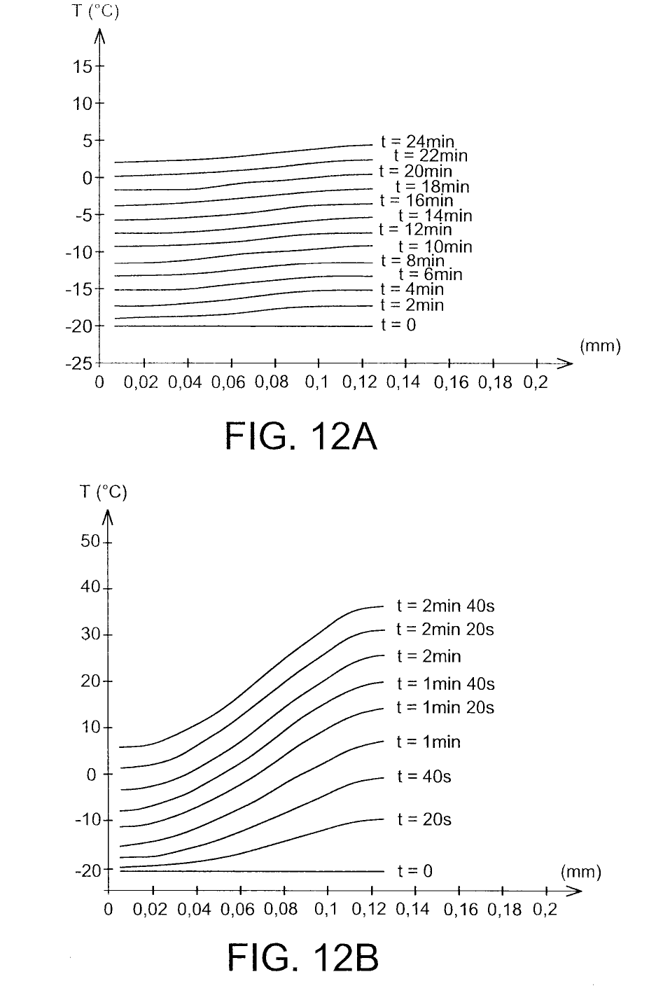

FIGS. 12A and 12B are graphical representations of the temperature profile, in ° C., as a function of the distance relative to the axis of the stack, in m, for two current density frequencies, 200 Hz and 1000 Hz respectively, for bipolar plates made of composite graphite-filled material, without any heat-transfer fluid flow.

### DETAILED DESCRIPTION OF EMBODIMENTS

The following description relates to a fuel cell, but the invention applies to any electrochemical device requiring heating the structure of which allows an induced current to appear.

The invention also applies to all types of fuel cells, and not only to cells of the PEMFC type.

The representations of the inductors are schematic, and they are generally more compact than in the illustrations.

Moreover the stack of cells described below has a square cross-section, but this is in no sense restrictive.

The stack could, for example, have a cross-section of any polygonal shape, a circular section or oval section, etc.

FIG. 1 is a schematic perspective representation of an embodiment of an electrochemical system according to the invention comprising a fuel cell comprising a stack 2 of electrochemical cells held between two terminal plates 4. The terminal plates are generally connected to one another by tie-rods (not represented) giving the stack mechanical solidity. They also have channels 6 in FIG. 1 to supply the stack with reactive gases and heat-transfer fluid. The bipolar plates at the ends of the stack are designated the “end bipolar plates”. The stack extends along a longitudinal axis Z. In the remainder of the description the bipolar plates and the end bipolar plates will not always be distinguished, and will be designated by “bipolar plates” unless the distinction is useful for understanding.

In the case of a PEMFC cell each cell comprises an anode and a cathode separated by a proton exchange membrane. The cells are connected in series through electrically conductive connection plates positioned between two successive cells electrically connecting the anodic electrode of one cell to the cathodic electrode of the next cell. Only a few bipolar plates are represented diagrammatically.

The bipolar plates thus provide an electrical series connection between the cells. The bipolar plates also distribute and collect the gases in each of the cells. In the remainder of the description results are presented which enable the performance of the invention to be assessed (generated power and thermal homogeneity), these results being obtained by modelling the heating obtained in several cells. For the sake of clarity only the results obtained for three bipolar plates are used as an illustration (Bipolar plates A, B and C). The bipolar plates are metal, being made for example of stainless steel, or of a graphite-based composite material, for example a material manufactured by the company BMCI; more generally the bipolar plates are made from materials sensitive to an applied magnetic field, which allow an induced current to flow in them.

The electrochemical system also comprises an induction heating system 10. In this embodiment the induction heating system comprises at least one first inductor 12 installed around the stack such that its axis is roughly identical with axis Z of the stack.

For reasons of clarity inductor 12 is not represented in FIG. 1, and is represented isolated in FIG. 2. The inductor preferably extends through the full height of the stack.

The inner section of first main inductor 12 is preferably such that it can be installed around the stack fitted with terminal plates. In the present example, first inductor 12 has at each of its longitudinal ends means 14 for attachment to the terminal plates. In the represented example these attachment means 14 are formed by two opposite protuberances having piercings which align with piercings made in the sides of the terminal plates. Screws or other connection means are introduced into these piercings.

Other attachment means are conceivable, and they can preferably be disassembled.

First inductor 12 is intended to be powered by an alternating current. This current causes a variable magnetic field to appear in the inductor. This variable magnetic field causes an induced current to appear in the bipolar plates, which are electrically conductive. The induced current dissipates the heat by the Joule effect in the bipolar plates.

The heat dissipated in each bipolar plate is not uniform throughout the entire cross-section of the bipolar plate, and the overall heating of each plate is then obtained by heat conduction. The entire stack is heated and the core of the stack reaches a temperature of over 0° C.; the solid water then changes into liquid state, and the gas circulation channels are then unblocked. The cell is ready to be started. The heating means are then deactivated and the fuel cell is started under improved conditions which will prevent it from being damaged.

All the bipolar plates are heated simultaneously.

In the represented embodiment the induction heating system comprises a second inductor 16 (represented isolated in FIG. 3) installed around upper terminal plate 4 such that its axis is perpendicular to the axis of the stack. Inductor 16 could be installed in proximity to the terminal plate without necessarily surrounding it.

When an electromagnetic field is generated in the second inductor an induced current appears in terminal plate 4, in the end bipolar plate, and in the bipolar plates in proximity. By this means the end bipolar plate is also heated directly by induction.

In this embodiment upper terminal plate 4 is made from one or more materials which are sensitive to an applied magnetic field. The lower terminal plate can also be made from one or more materials sensitive to an applied magnetic field.

The addition of this second inductor 16 is particularly advantageous. Indeed, due to the substantial thermal mass of terminal plates 4, the heating by first inductor 12 of the end bipolar plate can be less than that of the bipolar plates which are positioned in the centre of the stack. Second inductor 16 causes significant heating of the end bipolar plate, and also causes the terminal plate to be heated. A more uniform heating of the stack is then obtained.

In this example, second inductor 16 is attached to upper terminal plate 4 in a manner similar to the attachment of the main inductor on the terminal plates.

A second inductor can be positioned on the upper terminal plate opposite the inductor represented in FIG. 1 and/or one or two second inductors around the lower terminal plate.

A heating system comprising only one or more second inductors 16 located around the terminal plates does not go beyond the scope of the present invention.

As a variant the stack could consist of several groups of cells, where the cells of each group are connected in series, and the groups are connected in parallel. In addition, it can be envisaged to have several first inductors 12, powered separately, superposed on one another to surround the full height of the stack. For example, each first inductor 12 can surround a group of cells connected in series. By this means it would be possible to manage the heating of each stack individually. This variant is of interest to provide more heating at the ends, where the thermal losses are greater.

In this embodiment first inductor 12 can be structured such that it allows connection wires to pass through it to measure the voltage in one or more cells.

In FIG. 4 another embodiment of an electrochemical system according to the invention can be seen in which induction heating system 110 comprises at least one second inductor 116 positioned opposite a lateral face of the stack, the axis of which is perpendicular to the axis of the stack.

At least two second inductors are preferably positioned opposite one lateral face of the stack. In the represented example, two second inductors 116a, 116b are positioned one above the other, opposite a lateral face of the stack, covering roughly its full height. More than two inductors per face could be envisaged to optimise distribution of the heat generated by induction within the stack.

Inductors 116a, 116b are powered with current such that the current which flows in inductor 116a flows in a direction opposite to the current flowing in inductor 116b; in other words the current flowing in one of the inductors flows in a clockwise direction, and the current flowing in the other inductor flows in an anticlockwise direction. This current flow makes the magnetic field generated by one of the second inductors traverse the other second inductor, producing an alignment of the magnetic field roughly perpendicular to the plates of the stack, higher currents then being induced in the stack. In addition, the losses by induction are more uniform over the full height of the stack.

Inductors 116a, 116a are advantageously wound in opposite directions.

In the represented example the inductors are installed on a support plate 118 attached to terminal plates 104, for example by means of screws.

One or more inductors 116 are preferably installed opposite each face of the stack, by this means providing uniform heating of the outline of the bipolar plates. It could, however, be chosen to cover only one, two or three faces with the second inductors.

In FIG. 5 another example of pairs of second inductors 216a, 216b can be seen. Second inductors 216a, 216b are shaped such that they face two adjacent faces, both inductors thus being folded at right angles. Support plate 218 is also folded at right angles. As a variant they could cover three faces of the stack, by this means forming U shapes. Use of the same inductors to cover two or three faces enables the ratios between the generated thermal power, the mass and the heating time to be improved appreciably. This embodiment can, for example, be of great interest in the case of on-board applications, since it is then sought to reduce the mass of the fuel cell system. As a variant, the choice could be made to have several pairs of inductors supported by a single support plate having the shape of an angle bracket or having a U shape.

This embodiment is easy to install and enables access to one or more faces of the stack to be maintained. Installation and disassembly operations, as well as maintenance operations, are facilitated.

The operation of this embodiment is similar to that of the embodiment of FIG. 1.

The embodiment of FIG. 4 advantageously comprises at least one inductor 112 attached to the free face of upper terminal plate 104, its axis being roughly aligned with that of the stack. A first inductor can be envisaged on the free face of lower terminal plate 104 in addition to, or instead of, the first inductor on the upper terminal plate. These inductors cause an induced current to appear in the terminal plates and the end bipolar plates, and also causes them to be heated. This first inductor 112 provides appreciably the same advantages as those relating to second inductors 16 of FIG. 1.

A heating system comprising only one or two first inductor(s) 116 does not go beyond the scope of the present invention.

The heating performance of the fuel cell can advantageously be improved, for example, by reducing the inductor's perimeter locally, so as to increase the magnetic induction, for example by deforming the inductors, which lose their flatness, which then increases magnetic induction locally.

The inductors can be produced by known techniques. For example, the techniques of inductor followed by impregnation (in a vacuum) of an “attachment brace” and “inductor” assembly can be used.

The heating system is powered with alternating electrical current for example from the electrical source which is used to start the fuel cell, which is for example formed by a battery.

Each inductor is preferably powered through an inverter the frequency of which can be adjusted according to the heat requirement which is required locally or globally by the fuel cell. It can be envisaged to power several inductors by one single power source, or alternatively to have one power source for each inductor.

According to one example embodiment, the fuel cell comprises several stacks. It can then be envisaged to fit only one stack, or some of these stacks, with the induction heating system. Only the stack or stacks fitted with the heating system is/are used for a cold start. When this stack or these stacks are at a certain temperature and are operating, the heat generated by the operation of the cells is diffused to the heat-transfer fluid, which by flowing heats the other stacks. The available electrical energy can also be used rapidly to heat the whole of the stack.

The induction heating system according to the invention has the advantage that it can easily be optimised in order to be adapted for the different applications of the fuel cell system, such as the on-board application, for which the mass and volume criteria are important. In addition, it can be modified according to the typical usage cycles, the quantity of available energy, and also the environmental conditions. Lastly, the dimensioning of the heating system will be different depending on whether the cell is intended to start under extreme temperature conditions, or according to the tolerated duration over which the system must be maintained at an above-zero temperature, if such a mode is required by the application.

As previously mentioned, the geometry of the inductor(s) can be modified. The positioning of the inductor(s) also enables its/their operation to be optimised. Indeed, the closer the inductors are to the stack, the more effective the heating (in terms of efficiency and weight of the inductor). It will be noted that a minimum distance is observed in accordance with the insulation norms specific to each application, and with the dielectric properties of the insulating materials used to provide insulation between the fuel cell and the inductors.

The section of the inductor(s) can also be chosen to modify the heating system according to the operating conditions. For example, the larger the inductor's section the faster the heating can be; conversely the mass of the system is increased.

The current density within the inductor(s) can also be chosen to modify the heating system according to the operating conditions. For example, the lower of the current density the better the efficiency, the efficiency being in this case the ratio of the energy transmitted to the fuel cell divided by the electrical energy of the source used, but the heating is slower and the mass of the system is increased.

The maximum and minimum power frequency of the inductors also enables the heating system to be adapted. The higher the frequency the greater the transmitted power, but as due to the Kelvin effect within the bipolar plates above a certain frequency the temperature can be less uniform in the stack. Inductors can then be added to compensate for this lack of homogeneity, such as second inductors 16 or first inductors 112.

The heating system according to the invention also has the advantage that it can be used in several operating modes of the cell.

It enables the fuel cell to be maintained at an above-zero temperature using low-power heating.

It also enables the fuel cell to be heated at a “moderate speed”, but with great energy efficiency, without the heat-transfer fluid flowing.

It can also heat the system with “rapid” heating, but to the detriment of the energy efficiency, by causing the heat-transfer fluid liquid to flow).

In the case of certain channel and bipolar plate geometries, the heating system can guarantee that certain fuel or oxidising gas distribution channels and the zone of the membrane in proximity will be at an above-zero temperature, even if the core of the cell is still at a below-zero temperature. In this case starting the cell at a low current can be considered if the current will be distributed naturally in the above-zero temperature areas. Starting the fuel cell at a low current in this manner enables the temperature rise of the cell to be accelerated significantly and the quantity of electrical energy required for the start to be reduced, whilst ensuring starting conditions which do not risk damaging the fuel cell.

The induction heating system according to the invention consumes little energy since only the bipolar plates are heated. This results in efficient heating by heat conduction of the fuel cell's membranes and distribution channels. The zones of the heat-transfer fluid circuit are also heated locally by heat conduction. It can be noted that, since there is no requirement for the heat-transfer fluid to flow in order to heat the stack, the heat generated by the heating system is not evacuated within the cooling circuit by circulation of the heat-transfer fluid between the interior and exterior of the stack. This results in more efficient heating compared to systems using the circulation of the heat-transfer fluid.

Very advantageously, the induction heating implemented by the invention generates no undesirable effect for the fuel cell and does not accelerate the rate at which it ages. The generated electromagnetic wave has minimal interaction with the membrane of the fuel cell In addition, no electrical potential difference is applied between two successive bipolar plates. There is therefore no risk that the method by induction may lead to premature ageing of the fuel cell.

In addition, the induction heating system is intended to be activated when the cell is not in operation. The sensors which can be used, and the data transmitted to the actuators are not therefore active when the electromagnetic waves are being emitted. The risk of disturbance caused by the induced electromagnetic wave is therefore zero for most of the signals. In the case of the signals used during the heating phase, which are sensitive to electromagnetic disturbances, means known to those skilled in the art are implemented to cancel the impact of these disturbances (observance of a given separation distance, presence of shielding, etc.).

In addition, the electromagnetic field which generates losses within the fuel cell may possibly also generate losses in other electrical conductors present in proximity to the system. But the electromagnetic field is attenuated very rapidly as distance increases, and the losses generated within good conductors, such as copper or aluminium, are substantially lower than those generated within the bipolar plates.

The heating which can be experienced by the nearby elements is thus relatively low. In addition, it is advantageously possible to modify the geometry of the inductors and/or to add one or more elements channeling the magnetic flux (ferrites, steel, cast iron, etc.) to channel the magnetic flux out of the sensitive zones in order to reduce a possible excessive heating of one or more nearby elements.

According to the invention, the volume to be heated is limited. Switching the fuel cell to operational mode from a below-zero ambient temperature can be faster than in cells using the cooling circuit, and can require less energy.

The induction heating system also has the advantage that the thermal power generated within the stack can easily be adjusted. It can, for example, be adjusted by modifying the frequency of the electrical wave transmitted to the inductors.

The induction heating system prevents the fuel cell from being started in freezing conditions, with degraded cell performance. This start mode, although possible, can cause premature ageing of the elements constituting the fuel cell.

The induction heating system according to the invention can very easily be adapted to existing fuel cells; it has no impact on the other dimensioning aspects of the fuel cell system.

The heating system also requires no physical contact with the stack. Indeed, bearing in mind the thermal power which must be generated to heat the fuel cell, a minimum electrical insulation distance between the inductors and the fuel cell can easily be determined. There is thus no risk of a short-circuiting several bipolar plates of the stack, nor any risk of an electrical fault between the stack and the field windings.

In addition, the heating system enables the distribution of the power levels within the stack to be modified very easily; for example it can be desired to transmit more heating capacity to its ends. This distribution can be obtained by modifying the geometry of the inductors or by adding inductors close to the ends of the fuel cell, for example by means of inductors 16 or 112, or by adjusting the power supply frequency within some inductor windings.

Elements made of magnetic material can be added so as to channel the field lines, and therefore to be able to modify more easily the distribution of the losses within the stack.

The heating system according to the invention is also compatible with the different bipolar plate technologies which can be used in fuel cells. For example, in the case of a PEMFC cell the bipolar plates can be made of a graphite composite material or of a stainless steel.

Design and dimensioning of a heating system by direct induction according to the invention can be undertaken with the following methodology, used as an example:
a step of identification of the parameters of the “system” specifications required for the dimensioning of the heating device (minimum ambient temperature, duration of system shutdown (so as to define the management strategy of the “temperature maintenance” or “heating from ambient temperature” type, or maximum tolerated period for the system to be functional, tolerated weight for the heating system, etc.),
a step of identification of the geometry of the dimensions of the different components used in the fuel cell assembly,
a step of identification of the materials used in the fuel cell assembly, and physical specifications (electromagnetic and thermal) of the materials used (electrical resistivity, magnetic permeability, thermal conductivity, heat capacity, etc.),
a step of incorporation of the different parameters mentioned (geometrical, materials, initial temperature) in one or more digital simulation applications. Simulations of two types must be undertaken: firstly simulations of an electromagnetic nature (induction phenomenon, resolution of Maxwell equations) and simulations of a thermal nature. To undertake these simulations multi-dimensional applications (2D or better still 3D) can be used, for example applications designated “finite element” applications, or applications designated “finite difference” applications.

Both types of simulations can be undertaken directly using applications designated “coupled” applications (for example COMSOL Multiphysics) or independent applications (examples of applications which can be used: ANSYS Maxwell, Flux3D, Matlab, etc.).
A step of initiation of an iterative process (manual or automatic) for optimum dimensioning of the induction heating system so as to satisfy the specifications optimally:
Choice of materials used for the field winding(s),
Choice of the geometry of the field winding(s) (consideration of integration within the system, of parameters such as the required dielectric properties between the field winding and the fuel cell, of the manufacturing methods envisaged for producing the field windings, installation constraints, etc.),
Choice of the heating system's electrical specifications (current density in the field winding(s), frequency of the currents, power voltage,
a possible step of validation of the dimensioning through production of instrumented prototypes.

In addition, the heating system is of great interest from the standpoint of its integration. Indeed, the volume occupied by the inductors is confined in a volume most of which would be difficult to exploit to install other elements of the system in it. In addition, the heating system uses as additional elements only inductors of relatively low masses, and a small-volume inverter. In addition the heat transmission method does not use any intermediate means, unlike external gas or electric heaters. Thermal losses are consequently small. It should be noted that the mass and volume of external gas or electrical heaters can be significant compared to the fuel cell considered in isolation.

Furthermore, the heating system does not interact with the procedures for controlling the specific gases of the fuel cell. Its operation does not therefore interfere with the sensitive shutdown and start protocols of the state of the art. Moreover the efficiency of the heating system is independent of the state of moisture (quantity and homogeneity) of the cell during the shutdown phase.

Examples of characteristics of the heating system are now given, as non-restrictive examples. These examples enable the influence of the different parameters to be assessed (technology; system specifications; management strategy; maximum current density within the field windings). It should be noted that in the case of a system consisting of N “fuel cell” stacks, a single one of which would be used when starting, the mass assessed below is pooled for the N systems in question.

In the case of a heating system intended to provide “moderate speed” heating of the fuel cell, but with high energy efficiency, and/or to provide “rapid” heating of the system, and for a high-power cell consisting of metal bipolar plates, a first inductor 12 can have the following characteristics:

According to a first example, in the case of an inductor power supply with a frequency of 400 Hz:
excluding the mechanical support the copper inductor has a volume of approximately 2 dm³ of copper, or a mass of 18 kg of copper. In the case of an inductor made of an aluminium alloy, the quantity of metal required is equal to 3.3 dm³ since the current density is reduced to 3 A/mm² but the mass is 9 kg,
the direct heating power within the cell is estimated at 8400 W (at 400 Hz),
the energy losses within the inductor are then estimated at approximately 800 W if suitable wire, preventing the Kelvin effect, is used.

In the case of an inductor power supply frequency of 900 Hz:
excluding the mechanical support, the copper inductor has a volume of approximately 1.6 dm³, or 14.4 kg of copper. In the case of a copper inductor the volume is 2.6 dm³, or 7.2 kg of aluminium,
the direct heating power within the cell is estimated at 8400 W (at 900 Hz),
the energy losses within the inductor are lower, and estimated at approximately 560 W if suitable wire, preventing the Kelvin effect, is used.

In the example at 900 Hz, a slightly greater Kelvin effect within the material of the fuel cell can appear. This results in a slightly greater heterogeneity of the losses within the bipolar plates.

In the case of the embodiment of FIG. 4, the inductors' characteristics are as follows:
excluding the mechanical support, first two main coaxial inductors 112 have a copper conductor section measuring 420 mm² and the eight lateral inductors 116a, 116b have a section measuring 100 mm², the assembly being powered by a current with a frequency of 600 Hz. This dimensioning corresponds to a volume of 1 dm³ of copper or 9 kg of copper or 1.7 dm³ or 4.5 kg of aluminium.

In the case of a heating system intended to maintain the fuel cell at an above-zero temperature using low-power heating. A dissipated power of 1 W for each metal bipolar plate is considered sufficient to maintain the fuel cell at an above-zero temperature when the ambient temperature is −20° C.

With the heating system dimensioned above with 7.2 kg of aluminium, the losses within inductor 12 are then estimated at 30 W. This magnitude should be compared with the output power dissipated directly within the bipolar plates, which is 280 W. With a low efficiency for the inductor's power inverter of 80%, a global efficiency of the temperature maintenance system is obtained (output power to maintain the cell at temperature/electrical power used) of 72%.

As a comparison, the solution of the state of the art consisting in heating the heat-transfer fluid in offset fashion would require a total power of over 550 W (heating capacity required to maintain the cell and the heat-transfer fluid circuit at temperature, plus the power required to operate the circulation pump). In this less favourable case an overall efficiency of the temperature maintenance system of 50% is obtained.

Due to the invention the overall efficiency of the temperature maintenance system is increased appreciably.

Digital simulations will now be presented illustrating the performance of the heating system according to the invention. The goal of these simulations is to validate the proposed concept in quantitative terms. So as to reduce the simulation time models simpler than the 3D models described above, which can be used by those skilled in the art, were used. The electromagnetic simulations presented are of the axisymmetrical 2D type, and the simulations of the thermal type are of the 1D type, and were obtained from Matlab.

With these simulations a stack with a circular section is considered. In addition only the active and reactive elements were taken into account. From an electromagnetic standpoint, only the field windings, the bipolar plates and the power feeds were taken into account (the membranes and the cooling liquid, for example deionised water, were not considered, since their effect is negligible from an electromagnetic standpoint).

Firstly simulations relating to the induced current density in the bipolar plates are presented. It should be noted that the heat produced by the Joule effect is proportional to the induced current density.

FIGS. 7A to 7C represent the variation of the induced current density in A/m² within three metal bipolar plates designated A, B and C (FIG. 1) as a function of the distance relative to the axis of the stack, in mm, for the embodiment of FIG. 1 containing only the first inductor. The cell in question has a power of approximately 30 kW.

The equipment is approximately 350 mm high, corresponding to approximately 280 cells. The area of the bipolar plates is approximately 500 cm², bearing in mind that the active zone and the seals and fluid control zone, which corresponds to an average distance to the axis of 125 mm.

For example, the order of magnitude of the thickness of the bipolar plates is 1 mm in the case of stainless steel materials, and 5 mm for composite materials.

The first inductor is imagined to be a cylinder measuring 420 mm in height and with an average axis distance of 158 mm, and 2 mm thick.

Bipolar plate A is an end bipolar plate, bipolar plate C is a central bipolar plate, i.e. one which is located roughly at the centre of the stack, and bipolar plate B is an intermediate bipolar plate, located halfway between bipolar plate A and bipolar plate C.

In the case of FIG. 7A the density of the current flowing in the inductor is 5 A/mm² at a frequency of 100 Hz.

In the case of FIG. 7B the density of the current flowing in the inductor is 5 A/mm² at a frequency of 400 Hz.

In the case of FIG. 7C the density of the current flowing in the inductor is 4 A/mm² at a frequency of 900 Hz.

Initially a roughly uniform heating of the bipolar plates is observed. It is observed that this homogeneity decreases when the frequency increases. The appearance of a Kelvin effect is also observed at 400 Hz or above. In all cases, since the induced losses are directly proportional to the square of the induced current density, the heat generated by induction within the bipolar plates is greater at the periphery of the bipolar plates. The thermal diffusion within the bipolar plates is therefore taken into account in assessing the temperature profile within the bipolar plates.

In addition it is observed firstly that the frequency required to cause heating is low, less than several kHz. It is recalled that it is desired to increase the frequency such that the size of the inductor can be reduced. Account is taken of the Kelvin effect within the bipolar plates and the thermal diffusion within these abovementioned plates to identify the maximum acceptable frequency. It should be noted that a high frequency is not objectionable at the inverter(s) or at the inductor(s) since there is little Kelvin effect within good conductors such as copper or aluminium.

In FIG. 7D the variation of the induced current density, in A/m², within a metal bipolar end plate A of the stack in question can be seen for the simulation of FIGS. 7A to 7C, where this also comprises a second inductor 16 around the upper terminal plate, as represented in FIG. 1. The current density traversing the inductors is 5 A/mm² at a frequency of 100 Hz.

It is observed that the addition of this second inductor allows, at this same frequency of 100 Hz, the induced current density to be increased by 20%, and therefore the induction losses to be reduced by 40% within the bipolar plates located at the end of the stack.

In FIGS. 8A and 8B the simulations are made using the same stack as for the simulations of FIGS. 7A to 7C, but the bipolar plates are made of a graphite-filled composite material. With such bipolar plates the power of the cell is 5 kW.

The current density in the inductor is 5 A/mm² with a frequency of 200 Hz and 1000 Hz respectively for FIGS. 8A and 8B.

It is observed that the induced current densities are lower, and that the Kelvin effect does not appear, for power supply frequencies of less than one kHz. But, bearing in mind the greater core resistivity of these composite materials, which is at least several tens of times larger than that of stainless steel, the losses generated by induction are higher for the same frequency.

FIG. 9 represents the variation of the induced current density, in A/m², as a function of the distance of the axis of the stack, in mm, for the embodiment of FIG. 4, where the heating system comprises four pairs of second lateral inductors of effective section 100 mm², and an inductor of effective section 420 mm² at each end of the stack.

It is observed that end bipolar plate A is heated to a higher temperature due to the presence of the inductors at the ends of the stack.

Simulations showing the temperature within the stack will now be presented.

The simulations made also assume axisymmetrical geometry.

We shall consider the case of the metal PEMFC fuel cell, the dimensional characteristics of which have already been presented above. The average heating capacity of the bipolar plates and of the heat-transfer fluid within the bipolar plates was taken into account in these simulations. So as to simplify the simulation of the thermal diffusion mechanism, the geometry of the heat-transfer fluid channels has been simplified in the preliminary analysis undertaken, using an “average” model known to those skilled in the art. The bipolar plates are formed from channels distributed regularly in the section of the bipolar plates. If these channels are of thickness “e” and of width “L”, and if the distance between two successive channels is equal to “d”, the average thermal model consists in approximating the bipolar plate by a single channel having the same width of the bipolar plate and of the following thickness: “e*L/(L+d).

The initial temperature of the stack in question is equal to −20° C.

The geometry of the inductor taken into consideration is that of FIG. 1 with a single inductor 12, bearing in mind that the electromagnetic simulation results described above have shown that the currents induced in both geometries can be very close.

FIGS. 10A to 10C represent the temperature profile, in ° C., as a function of the distance relative to the axis of the stack, in m.

Each curve represents the temperature profile in a bipolar plate along the length of its diameter, at a given instant. For example, FIG. 10A shows the temperature profiles taken every 4 minutes, from time 0 min. to time 40 min. Where the profile at 0 min. is the lowest curve (temperature throughout the bipolar plate at −20° C.), and the profile at 40 min. is the highest curve (temperature at the centre of the plate slightly above 0° C. and temperature in the outer edge of the plate almost 60° C.).

It is considered that the stack is fully heated when the temperature of the stack at its axis is higher than 0° C., ensuring that the water is in the liquid state.

In the case of FIG. 10A the current generator has a single frequency of 100 Hz. The time to heat the stack fully is 40 min.

In the case of FIG. 10B the current generator has a variable frequency. The frequency is 200 Hz from 0 to 4 min., 150 Hz from 4 min. to 8 min. and 100 Hz from 8 min. to 26 min. The time to heat the stack fully is 26 min. A variable frequency power supply enables the heating time to be reduced.

In the case of FIG. 10C the current generator has a variable frequency. The frequency is 200 Hz from 0 to 4 min. and 150 Hz from 4 min. to 10 min.

The time to heat the stack fully is 30 min., but with a heating time of 10 min. With this heating strategy a very steep thermal gradient is rapidly obtained, the time to obtain full heating of the stack is longer than with the strategy of FIG. 10B, but this strategy is better in terms of efficiency, since the heating system is used only for the first 10 minutes. The following 20 minutes are used to homogenize the temperature within the stack by thermal diffusion.

FIGS. 11A and 11C represent the temperature profiles within the stack if the heat-transfer fluid is circulating.

It is imagined that the temperature in the core of the stack (except for the outer zone between a radius R of 10 cm and 12.5 cm) is at a uniform temperature, due to the circulation of the heat-transfer fluid. The results presented are obtained by imagining that the volume of the fluid outside the stack, which must be heated, is equal to 80% of the volume of the fluid within the fuel cell.

In the case of FIG. 11A the frequency of the power current is 100 Hz.

In the case of FIG. 11B the frequency of the power current is 400 Hz.

This being so, even if the quantity of the heat-transfer fluid to be heated is greater, heating is more rapid than in the case without any circulation of the heat-transfer fluid: the heating duration, at 100 Hz, is 40 minutes without any circulation of heat-transfer fluid, whereas it is 28 minutes if the heat-transfer fluid is circulating. In addition, due to the temperature homogeneity obtained due to the circulation of the heat-transfer fluid, it is possible to envisage a higher frequency for the inductors' power supply. In the case of the geometry used, the time to heat the cell fully becomes less than 4 minutes at the frequency of 400 Hz. In this figure we observe that the temperature is not uniform in plates with a radius greater than 10 cm. This derives from the simulated model, which represents a bipolar plate geometry in which the radially outer surface of the bipolar plate has no heat-transfer fluid channels, implying that in a radial outer zone beyond a radius of 10 cm the temperature is not uniform.

FIGS. 12A and 12B represent the temperature profile as a function of the distance relative to the axis of the stack, in metres, taking into account that the bipolar plates made of composite material contain graphite.

In the case of FIG. 12A the frequency of the power current is 200 Hz.

In the case of FIG. 12B the frequency of the power current is 1000 Hz.

Bearing in mind the heat conduction of the composite materials and the thickness of the bipolar plates, for a power supply frequency of 1000 Hz the heating time is less than 2 min. 20 s, but a steep thermal gradient is observed.

These simulations show the efficiency of the induction heating system according to the invention, and particularly in the case of a high power current frequency and when the heat-transfer fluid flows, a very short heating time and relatively uniform heating are obtained.

The heating capacities generated within the bipolar plates within the stack are compatible with the sought application, or superior to the requirement in the case of frequencies of the order of 100 Hz to 10 kHz. Such power characteristics enable the active zones of the fuel cell to be heated rapidly, completely or partially, before it is started.

The power dissipated within the stack can be controlled directly due by means of the inductors' power supply frequency. As mentioned above, the heating system can allow, simultaneously, maintenance at an above-zero temperature for short-duration shutdowns, or rapid heating of the fuel cell in the case of a cold start from a below-zero temperature.

The fuel cell system and heating system can, for example, be used as a means of electrical traction in a motor vehicle, or as an energy storage station dedicated to electrical distribution networks.

1-15. (canceled)

16. Electrochemical system comprising at least one electrochemical device comprising a stack of electrochemical cells connected electrically to one another by bipolar plates interposed between two successive electrochemical cells of the stack, said stack being positioned between two terminal plates, said stack extending along an axis, said electrochemical system comprising means to supply the cells with reactive fluids, means of circulation of a heat-transfer fluid to flow through the stack, and at least one induction heating system comprising at least one pair of second inductors, the axis of which is substantially perpendicular to the axis of the stack, said second inductors being configured to cause an appearance of induced current in at least one bipolar plate, causing said bipolar plate to be heated by a Joule effect, said pair of second inductors being positioned opposite at least one common lateral face, each second inductor of said pair being powered with a current such that a current flowing in one of the second inductors of the pair flows in an opposite direction to a current flowing in the other of the second inductors of the pair.

17. Electrochemical system according to claim 16, in which the stack has a polygonal cross-section, the second inductors being shaped such that they are opposite at least two lateral faces.

18. Electrochemical system according to claim 16, in which the at least one induction heating system also comprises at least one first inductor, an axis of which is coaxial with the stack.

19. Electrochemical system according to claim 18, in which the first inductor is positioned around the stack in a manner substantially coaxial with the stack.

20. Electrochemical system according to claim 19, in which the first inductor extends throughout a full height of the stack.

21. Electrochemical system according to claim 16, in which the first and second inductors are installed on a support plate attached to at least one terminal plate.

22. Electrochemical system according to claim 16, in which the at least one induction heating system also comprises at least one inductor positioned around or in proximity to a terminal plate.

23. Electrochemical system according to claim 18, in which the first inductor is installed on at least one terminal plate on its face opposite a face facing the stack.

24. Electrochemical system according to claims 16, comprising an alternating current power source and an inverter.

25. Electrochemical system according to claim 16, in which the electrochemical device comprises several stacks, and said heating system heating at least one stack.

26. Electrochemical system according to claim 16, in which the electrochemical device is a fuel cell.

27. Electrochemical system according to claim 16, in which the electrochemical device is a PEMFC fuel cell.

28. Method of operation of the electrochemical system according to claim 16, comprising the following steps:
activating the heating system by induction outside an operational phase of the electrochemical device,
heating of the stack by generation of an induced current in at least one connection plate,
causing shutdown of the heating system,
starting the electrochemical device.

29. Method of operation of the electrochemical system according to claim 28, in which the heating system is activated after a prolonged shutdown phase of the electrochemical device, and in which the heating system is shut down when a temperature within the stack is higher than a melting point of any water inside the electrochemical generator and/or in which the heating system is activated during a short-duration shutdown of the electrochemical device so as to maintain the stack of the electrochemical device at temperature.

30. Method of operation according to claim 28, in which the alternating current has a variable frequency.

31. Method of operation according to claim 28, in which a heat-transfer fluid circulates during a heating phase.
